(19) United States
(12) Patent Application Publication
(10) Pub. No.: US 2007/0001578 A1
(43) Pub. Date: Jan. 4, 2007

(54) Multiwavelength laser diode

(76) Inventors: Hideto Iki, Miyagi (JP); Shinya Sato, Miyagi (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 11/452,672

(22) Filed: Jun. 14, 2006

(30) Foreign Application Priority Data
Jun. 17, 2005 (JP) JP 2005-178480

(51) Int. Cl. H01J 29/89

(52) U.S. Cl. 313/478

(57) ABSTRACT

Rear end face films of a first device portion and a second device portion have a first reflective film in which one or a plurality of sets of a first rear end face film with a refractive index of n1 and a second rear end face film with a refractive index of n2 (≧n1) are layered on the rear end face; and a second reflective film in which one or a plurality of sets of a third rear end face film with a refractive index of n3 (≦n1) and a fourth rear end face film with a refractive index of n4 (≧n1) are layered on the first reflective film.

### CROSS REFERENCES TO RELATED APPLICATIONS

The present invention contains subject matter related to Japanese Patent Application JP 2005-178480 filed in the Japanese Patent Office on Jun. 17, 2005, the entire contents of which being incorporated herein by reference.

### BACKGROUND OF THE INVENTION

1. Field of the Invention

The present invention relates to a monolithic multiwavelength laser diode, particularly to a multiwavelength laser diode with an improved reflector film on the high reflectance side.

2. Description of the Related Art

In recent years, in the field of laser diodes (LD), plural-wavelength laser devices having a plurality of light emitting portions with different light emitting wavelengths on the same substrate (or base) have been actively developed. The plural-wavelength laser devices are used as, for example, a light source for optical disk devices.

In such optical disk devices, laser light in the 780 nm band is used for reproduction in a CD (Compact Disk), and is used for recording and reproduction in a recordable optical disk such as a CD-R (CD Recordable), a CD-RW (CD Rewritable), and an MD (Mini Disk). In addition, in such optical disk devices, laser light in the 660 nm band is used for recording and reproduction in a DVD (Digital Versatile Disk). By mounting the multi-wavelength laser device on the optical disk device, recording or reproduction becomes available for any types of existing optical disks. It is possible to expand applications by using multi-wavelengths as above.

In such a monolithic plural-wavelength laser device, in general, similarly to in a single-wavelength laser device, a low reflector film and a high reflector film which are matched to each laser light wavelength λ are formed in one process on the whole end face of the laser device, and light is effectively extracted from the end face on the low reflector film side (Japanese Unexamined Patent Application Publication No. 2001-257413). In order to obtain high reflectance, the high reflector film generally has a multilayer structure in which a low refractive index layer and a high refractive index layer are alternately layered. In this case, the materials thereof are combined so that the refractive index difference between the low refractive index layer and the high refractive index layer becomes large. As a combination of the low refractive index layer and the high refractive index layer, in general, a combination of aluminum oxide (Al₂O₃, refractive index: 1.65) and amorphous silicon (a-Si, refractive index: 2.45), a combination of aluminum oxide and titanium oxide (TiO₂, refractive index: 2.45) and the like are used.

### SUMMARY OF THE INVENTION

In the former combination, a high refractive index difference can be obtained. However, in such a former combination, there is a disadvantage that since a-Si absorbs light at the 660 nm band, and therefore it becomes difficult to realize a high refractive index in the 660 nm band. Further, in the latter combination, the refractive index difference is not so large. Therefore, there is a disadvantage that the reflectance of the high refractive index layer is high only in the narrow band, and it is difficult to realize high reflectance both in the 660 nm band and in the 780 nm band.

In view of such disadvantages, in the present invention, it is desirable to provide a multiwavelength laser diode capable of realizing high reflectance in a given waveband.

According to an embodiment of the present invention, there is provided a multiwavelength laser diode including a substrate, a first device portion which is formed on the substrate and oscillates laser light of a first wavelength, and a second device portion which is formed on the substrate and oscillates laser light of a second wavelength. A front end face film is formed in one process on a front end face of the first device portion and a front end face of the second device portion, and a rear end face film is formed in one process on a rear end face of the first device portion and a rear end face of the second device portion. The rear end face film has a first reflective film in which one or a plurality of sets of a first rear end face film with a refractive index of n1 and a second rear end face film with a refractive index of n2 (>n1) are layered on the rear end face, and a second reflective film in which one or a plurality of sets of a third rear end face film with a refractive index of n3 (≦n1) and a fourth rear end face film with a refractive index of n4 (>n1) are layered on the first reflective film.

In the multiwavelength laser diode of the embodiment of the present invention, when a current is respectively injected in the first device portion and the second device portion, light emission is generated inside the respective light emitting regions. Light generated in the respective regions is reflected by the front end face film and the rear end face film in which the relatively low refractive index film (first rear end face film and third rear end face film) and the relatively high refractive index film (second rear end face film and fourth rear end face film) are alternately layered. Then, laser oscillation is generated. The laser light of the first wavelength is emitted outside from the first device portion side of the front end face film, and the laser light of the second wavelength is emitted outside from the second device portion side of the front end face film.

At that time, the film on the rear end face side (first reflective film) of the rear end face film preferably has a heat release function and a reflective function. The film on the outer side (second reflective film) of the rear end face film preferably has a high reflective function. In order that the first reflective film has such a function, the first rear end face film preferably includes a material with favorable heat release characteristics such as Al₂O₃ and AlN, and the second rear end face film preferably includes a material with high heat stability and a high refractive index such as TiO₂. Further, in order that the second reflective film has the foregoing function, the third rear end face film preferably includes a material with a low refractive index such as SiO₂ (refractive index: 1.45), and the fourth rear end face film preferably includes a material with a high refractive index such as TiO₂ (refractive index: 2.45).

When the third rear end face film is made of a material similar to of the first rear end face film such as Al₂O₃ and AlN, the fourth rear end face film is preferably made of a material with a refractive index higher than the refractive index of TiO₂ such as a-Si (refractive index: 3.65) so that the refractive index difference between the third rear end face film and the fourth rear end face film becomes large. Further, a third reflective film having a heat release function and a reflective function may be provided outside of the second reflective film. In the third reflective film, one or a plurality of sets of a fifth rear end face film with a refractive index of n5 (≦n1) (relatively low refractive index film) and a sixth rear end face film with a refractive index of n6 (>n1) (relatively high refractive index film) are layered on the second reflective film. The third reflective film is made of a material similar to of the first reflective film.

As above, by forming the rear end face film from the plurality of reflective films, the range of choice in terms of arrangement, the number of layers, materials and the like for each reflective film can be widened. In the result, unfavorable characteristics of one material can be improved with arrangement, the total number of layers, or other material. For example, when a SiO₂ film is used as a low refractive index film in order to improve reflectance of the rear end face film, an Al₂O₃ film or an AlN film which has higher heat release characteristics and higher film-forming speed than the SiO₂ film is used as a low refractive index film on the rear end face side of the rear end face film. Thereby, heat release characteristics and film-forming speed can be improved, and reflectance of the rear end face film can be high in the wide band. Therefore, high reflectance can be obtained in a given wavelength band with heat release characteristics and film-forming speed in the practical range.

According to the multiwavelength laser diode of the embodiment of the present invention, the rear end face film composed of a plurality of reflective films is provided. Therefore, reflectance of the rear end face film can be high in the wide band. Thereby, a high reflectance can be realized in a given wavelength band (wavelength band including the first wavelength and the second wavelength). For example, a high reflectance can be realized in the 660 nm band and in the 780 nm band.

Other and further objects, features and advantages of the invention will appear more fully from the following description.

### BRIEF DESCRIPTION OF THE DRAWINGS

FIG. 1 is a cross sectional structure view of a two-wavelength laser diode according to a first embodiment of the present invention;

FIG. 2 is a planar structure view of the two-wavelength laser diode of FIG. 1;

FIGS. 3A and 3B are cross sections for explaining part of manufacturing steps of the two-wavelength laser diode of FIG. 1;

FIG. 4 is a diagram showing an illustrative example of a reflectance distribution of a known rear end face film;

FIG. 5 is a diagram showing an illustrative example of a reflectance distribution of a rear end face film of FIG. 2;

FIG. 6 is a diagram showing an illustrative example of a reflectance distribution of a known front end face film;

FIG. 7 is a diagram showing an illustrative example of a reflectance distribution of a front end face film of FIG. 2;

FIG. 8 is a planar structure view of a two-wavelength laser diode according to a second embodiment of the present invention;

FIG. 9 is a diagram showing an illustrative example of a reflectance distribution of a rear end face film of FIG. 8;

FIG. 10 is a planar structure view of a two-wavelength laser diode according to a third embodiment of the present invention;

FIG. 11 is a diagram showing an illustrative example of a reflectance distribution of a front end face film of FIG. 10;

FIG. 12 is a planar structure view of a two-wavelength laser diode according to a fourth embodiment of the present invention;

FIG. 13 is a diagram showing an illustrative example of a reflectance distribution of a front end face film of FIG. 12;

FIG. 14 is a planar structure view of a two-wavelength laser diode according to a fifth embodiment of the present invention; and

FIG. 15 is a diagram showing an illustrative example of a reflectance distribution of a front end face film of FIG. 14.

### DETAILED DESCRIPTION OF THE PREFERRED EMBODIMENTS

Descriptions will be given of an embodiment of the present invention in detail with reference to the drawings.

[First Embodiment]

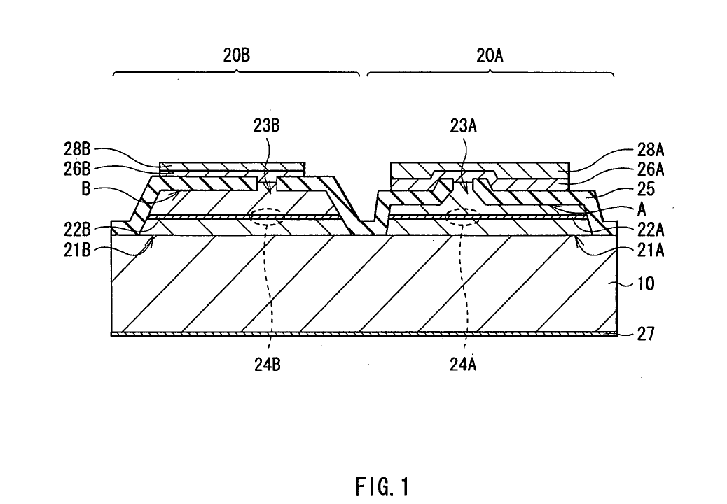

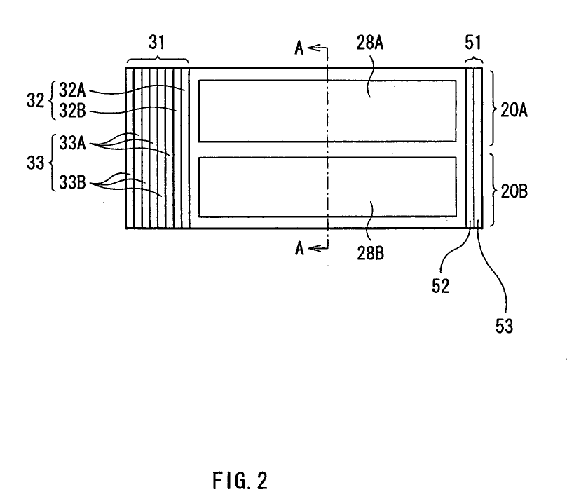

FIG. 1 shows a cross sectional structure of a two-wavelength laser diode according to a first embodiment of the present invention. FIG. 2 shows a planar structure of the two-wavelength laser diode of FIG. 1. FIG. 1 shows a cross sectional structure taken along arrow A-A of FIG. 2. Further, FIG. 1 and FIG. 2 show models of the two-wavelength laser diode device, and the dimensions and the shapes are different from those used actually.

The two-wavelength laser diode device is a monolithic laser diode, in which a first device portion 20A and a second device portion 20B are arrayed on a substrate 10.

(First Device Portion 20A)

The first device portion 20A is a laser diode device capable of emitting light in the 660 nm band, and is made of an aluminum-gallium-indium-phosphorus (AlGaInP) Group III-V compound semiconductor. Here, the aluminum-gallium-indium-phosphorus Group III-V compound semiconductor means a semiconductor containing at least aluminum (Al), gallium (Ga), and indium (In) of Group 3B elements in the short period periodic table, and at least phosphorus (P) of Group 5B elements in the short period periodic table.

In the first device portion 20A, a semiconductor layer 21A is grown on the substrate 10. The semiconductor layer 21A includes an n-type cladding layer, an active layer 22A, a p-type cladding layer, and a p-side contact layer. These layers are not particularly shown except the active layer 22A.

Specifically, the substrate 10 is made of, for example, n-type GaAs, and is about 100 μm thick, for example.

The n-type cladding layer is made of n-type AlGaInP being 1.5 μm thick, for example. The active layer 22A has a multi-quantum well structure composed of a well layer and a barrier layer which are respectively formed from differently composed AlₓGa_{y}In_{1-x-y}P (where x≧0 and y≧0) being 40 nm thick, for example. The p-type cladding layer is made of p-type AlGaInP being 1.5 μm thick, for example. The p-side contact layer is made of p-type GaP being 0.5 μm thick, for example. Parts of the p-type cladding layer and the p-side contact layer have a stripe-shaped ridge 23A extending in the resonator direction, and thereby current is confined. A region of the active layer 22A corresponding to the ridge 23A is a first light emitting point 24A.

An insulating layer 25 is provided on the surface which continues from the side face of the ridge 23A to the surface of the p-type cladding layer (hereinafter referred to as a surface A). The insulating layer 25 is made of an insulating material such as SiO₂, ZrOx, and SiN being about 300 nm thick, for example. The insulating layer 25 electrically insulates the semiconductor layer 21A of the first device portion 20A from a semiconductor layer 21B (described later) of the second device portion 20B. In addition, the insulating layer 25 allows current to flow only from the top face of the ridge 23A and a ridge 23B (described later) into the active layer 22A. Therefore, the insulating layer 25 has a device separation function and a current confinement function.

A p-side electrode 26A is provided on the surface which continues from the top face of the ridge 23A (surface of the p-side contact layer) to the surface of the insulating layer 25. The p-side electrode 26A is electrically connected to the p-side contact layer. Meanwhile, an n-side electrode 27 is provided on the rear face of the substrate 10, and is electrically connected to the substrate 10.

A wiring layer 28A is provided on the p-side electrode 26A, and is electrically connected to the p-side electrode 26A. The p-side electrode 26A is connected to a positive side power source (not shown) via a wiring electrically connected to the wiring layer 28A (not shown). The n-side electrode 27 is electrically connected to a wiring (not shown), and is connected to a negative side power source (not shown) via the wiring. The p-side electrode 26A and the n-side electrode 27A have a multilayer structure in which, for example, Ti being 15 nm thick, Pt being 50 nm thick, Au being 300 nm thick are layered in this order. The wiring layer 28A is made of Au being 8.7 μm thick, for example.

(Second Device Portion 20B)

The second device portion 20B is a laser diode device capable of emitting light in 780 nm band, and is made of a gallium-arsenic (GaAs) Group III-V compound semiconductor. Here, the gallium-arsenic Group III-V compound semiconductor means a semiconductor containing at least gallium (Ga) of Group 3B elements in the short period periodic table, and at least arsenic (As) of Group 5B elements in the short period periodic table.

Similarly to in the first light emitting device 20A, in the second device portion 20B, the semiconductor layer 21B is grown on the substrate 10. The semiconductor layer 21B includes an n-type cladding layer, an active layer 22B, a p-type cladding layer, and a p-side contact layer. These layers are not particularly shown except the active layer 22B.

Specifically, the n-type cladding layer is made of n-type AlGaAs being 1.5 μm thick, for example. The active layer 22B has a multi-quantum well structure composed of a well layer and a barrier layer which are respectively formed from differently composed AlₓGa₁₋ₓAs (where x≧0) being 35 nm thick, for example. The p-type cladding layer is made of p-type AlGaAs being 1.0 μm thick, for example. The p-side contact layer is made of p-type GaAs being 0.5 μm thick, for example. Parts of the p-type cladding layer and the p-side contact layer have the stripe-shaped ridge 23B extending in the resonator direction, and thereby current is confined. A region of the active layer 22B corresponding to the ridge 23B is a second light emitting point 24B.

The foregoing insulating layer 25 is provided on the surface which continues from the side face of the ridge 23B to the surface of the p-type cladding layer (hereinafter referred to as a surface B).

A p-side electrode 26B is provided on the surface which continues from the top face of the ridge 23B (surface of the p-side contact layer) to the surface of the insulating layer 25. The p-side electrode 26B is electrically connected to the p-side contact layer. Meanwhile, the foregoing n-side electrode 27 is provided on the rear face of the substrate 10, and is electrically connected to the substrate 10.

A wiring layer 28B is provided on the p-side electrode 26B, and is electrically connected to the p-side electrode 26B. The p-side electrode 26B is connected to a positive side power source (not shown) via a wiring electrically connected to the wiring layer 28B (not shown). The p-side electrode 26B is structured by, for example, layering Ti being 15 nm thick, Pt being 50 nm thick, and Au being 300 nm thick in this order. The wiring layer 28B is made of Au being 4.5 μm thick, for example.

(Front End Face Film and Rear End Face Film)

Further, as shown in FIG. 2, a pair of reflector films is formed in one process respectively on the surface perpendicular to the extending direction of the ridge 23A of the first device portion 20A (axis direction) (the surface perpendicular to the extending direction of the ridge 23B of the second device portion 20B (axis direction)).

A film on the reflective side of the pair of reflector films (rear end face film 31) has a first reflective film 32 in which one or a plurality of sets of a first rear end face film 32A with a refractive index of n1 and a film thickness of λo and a second rear end face film 32B with a refractive index of n2 (>n1) and a film thickness of λo are layered on the rear end face, and a second reflective film 33 in which one or a plurality of sets of a third rear end face film 33A with a refractive index of n3 (≦n1) and a film thickness of λo and a fourth rear end face film 33B with a refractive index of n4 (>n1) and a film thickness of λo are layered on the first reflective film 32.

Specifically, the first rear end face film 32A is made of Al₂O₃ (thermal conductivity: 0.2, refractive index n1: 1.65) or AlN (thermal conductivity: 2.85, refractive index n1: 2.11). The second rear end face film 32B is made of TiO₂ (refractive index n2: 2.45 (>n1)). Al₂O₃ and AlN respectively have properties that the heat release characteristics are high and the refractive index is low. Meanwhile, TiO₂ has properties that the refractive index and the heat stability (non-deformability to heat) are high. SiN (refractive index: 2.0) is not preferably used for the second rear end face film 32B since the stress to heat is large and the heat stability is low though the refractive index is large. Thereby, the first reflective film 32 has a heat release function and a reflective function. The third rear end face film 33A is made of SiO₂ (thermal conductivity: 0.125, refractive index n3: 1.45 (<n1)). The fourth rear end face film 33B is made of TiO₂ (refractive index n4: 2.45 (>n1)). Since the refractive index difference between SiO₂ and TiO₂ is large, 1.0, the second reflective film 33 has a high reflective function.

The foregoing SiO₂ has a significantly low refractive index and is suitably utilized as a material of the reflective film. Meanwhile, SiO₂ has characteristics that the film-forming speed is significantly slow and the throughput is low. Thus, in order to improve the throughput, the use of SiO₂ is desirably curtailed as long as possible. Therefore, in this embodiment, as described above, the second reflective film 33 with high reflectance is formed from a small number of layers of SiO₂ and TiO₂ with a high refractive index. Thereby, the use of SiO₂ is curtailed, and the throughput is improved. In the first reflective film 32 not needing low refractive index material such as SiO₂, Al₂O₃ or AlN with a high film-forming speed is used instead of SiO₂ as a layer with a low refractive index, and thereby the throughput is further improved. Further, since SiO₂ has slightly low heat release characteristics and slightly low heat stability compared to Al₂O₃, it is desirable to keep the film containing SiO₂ away from the rear end face. Therefore, in this embodiment, the first reflective film 32 with high heat release characteristics is provided between the second reflective film 33 containing SiO₂ and the rear end face, and thereby influence of heat is reduced.

As above, by forming the rear end face film 31 from the plurality reflective films (first reflective film 32 and the second reflective film 33), the range of choice in terms of arrangement, the number of layers, materials and the like for each reflective film can be widened. Thereby, as described above, unfavorable characteristics of one material can be improved with arrangement, the total number of layers, or other material.

Meanwhile, a film on the main emitting side (front end face film 51) has a multilayer structure in which a high refractive index layer 52 with a given thickness and a low refractive index layer 53 with a thickness corresponding to the thickness of the high refractive index layer 52 are layered in this order on the front end face, and is adjusted to meet a first specification.

Specifically, the high refractive index layer 52 is made of an Al₂O₃ layer, and the low refractive index layer 53 is made of a SiO₂ layer. The thickness of the Al₂O₃ layer is from 30 nm to 60 nm, which is different from the value obtained by dividing 660 nm or 780 nm by 4n (n is a refractive index) or the value obtained by dividing the average value of 660 nm and 780 nm by 4n (value derived from the function of laser light wavelength). For example, when the thickness of the Al₂O₃ layer is about 30 nm, the thickness of the SiO₂ layer is from 85 nm to 120 nm; when the thickness of the Al₂O₃ layer is about 50 nm, the thickness of the SiO₂ layer is from 50 nm to 70 nm; and when the thickness of the Al₂O₃ layer is about 60 nm, the thickness of the SiO₂ layer is from 40 nm to 80 nm.

The two-wavelength laser diode device having the foregoing structure can be manufactured as follows, for example.

First, the laser structure of the first device portion 20A is manufactured. For this manufacturing, the semiconductor layer 21A on the substrate 10 is formed by, for example, MOCVD method. As a raw material of the AlGaInP semiconductor, for example, trimethyl aluminum (TMA), trimethyl gallium (TMG), trimethyl indium (TMIn), or phosphine (PH₃) is used. As a raw material of donor impurity, for example, hydrogen selenide (H₂Se) is used. As a raw material of acceptor impurity, for example, dimethyl zinc (DMZn) is used.

Specifically, first, the n-side contact layer, the n-type cladding layer, the active layer 22A, the p-type cladding layer, and the p-type contact layer are layered in this order on the substrate 10 to form the semiconductor layer 21A. Subsequently, the p-side contact layer and the p-type cladding layer are provided with patterning by, for example, dry etching method so that a narrow stripe-shaped convex portion is obtained to form the ridge 23A.

Next, the laser structure of the second device portion 20B is manufactured. For this manufacturing, the semiconductor layer 21B on the substrate 10 is formed by, for example, MOCVD method. As a raw material of the GaAs semiconductor, for example, TMA, TMG, TMIn, or arsine (AsH₃) is used. As a raw material of donor impurity, for example, H₂Se is used. As a raw material of acceptor impurity, for example, DMZn is used.

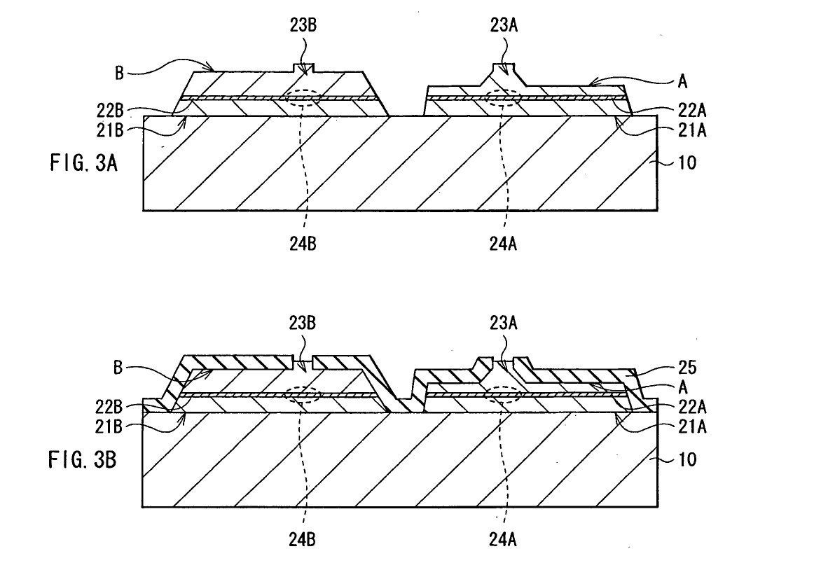

Specifically, first, the n-side contact layer, the n-type cladding layer, the active layer 22B, the p-type cladding layer, and the p-type contact layer are layered in this order over the substrate 10 to form the semiconductor layer 21B. Subsequently, the p-side contact layer and the p-type cladding layer are provided with patterning by, for example, dry etching method so that a narrow stripe-shaped convex portion is obtained to form the ridge 23B. Thereby, as shown in FIG. 3A, the laser structure of the first device portion 20A and the laser structure of the second device portion 20B are arrayed on the substrate 10.

Next, an insulating material such as SiN is formed on the top face of the ridges 23A and 23B and on the surfaces A and B by vapor deposition or sputtering. After that, as shown in FIG. 3B, the region of the insulating material corresponding to the top face of the ridges 23A and 23B is removed by etching. Thereby, the insulating layer 25 is formed on the surfaces A and B.

Next, as shown in FIG. 1, the p-side electrode 26A and the wiring layer 28A are layered and formed in this order on the surface which continues from the surface of the p-side contact layer of the ridge 23A to the surface of the insulating layer 25. Further, the p-side electrode 26B and the wiring layer 28B are layered and formed in this order on the surface which continues from the surface of the p-side contact layer of the ridge 23B to the surface of the insulating layer 25. Further, the n-side electrode 27 is formed on the rear face of the substrate 10.

Next, the resultant is cleaved on the face perpendicular to the extending direction of the ridges 23A and 23B. After that, the front end face film 31 and the rear end face film 32 are formed in one process on cleaved faces. As above, the two-wavelength laser diode device in this embodiment is manufactured.

Next, action and effect of the two-wavelength laser diode device in this embodiment will be described.

In the two-wavelength laser diode device in this embodiment, when a given voltage is applied to between the p-side electrodes 26A, 26B and the n-side electrode 27, a current is injected into the active layers 22A and 22B, and light emission is generated due to electron-hole recombination. Light emitted in the respective active layers 22A and 22B is reflected by the front end face film 30 and the rear end face film 31 and laser oscillation is generated. Then, laser light in the wavelength of 660 nm is emitted outside from the first device portion 20A side of the front end face film 30, and laser light in the wavelength of 780 nm is emitted outside from the second device portion 20B side of the front end face film 30. As above, the first device portion 20A and the second device portion 20B can emit laser light in the wavelength different from each other.

The rear end face film 31 has the single structure which is formed in one process on the rear end face as described above. Thus, the rear end face film 31 does not have a plurality of structures in which the material, the film thickness, the layer structure and the like are adjusted according to the site from which laser light is emitted. Therefore, it is necessary to realize reflectance (90% or more) in the practical range for laser light in the both wavelengths by the single structure.

In general, where an intermediate wavelength (λ1+λ2)/2 obtained by adding a wavelength λ1 of one laser light and a wavelength λ2 of the other laser light and dividing the sum by 2 is λo, the single structured rear end face film has a structure in which a plurality of sets of a film with high reflectance and a film thickness of λo and a film with low reflectance and a film thickness of λo are layered. In the rear end face film having such a structure, the waveband corresponding to the reflectance in the practical range is narrow. Therefore, when the film thickness of each film composing the rear end face film varies according to manufacturing error or the like, reflectance in the waveband of at least one laser light may become lower than the practical range, and the yield may be decreased.

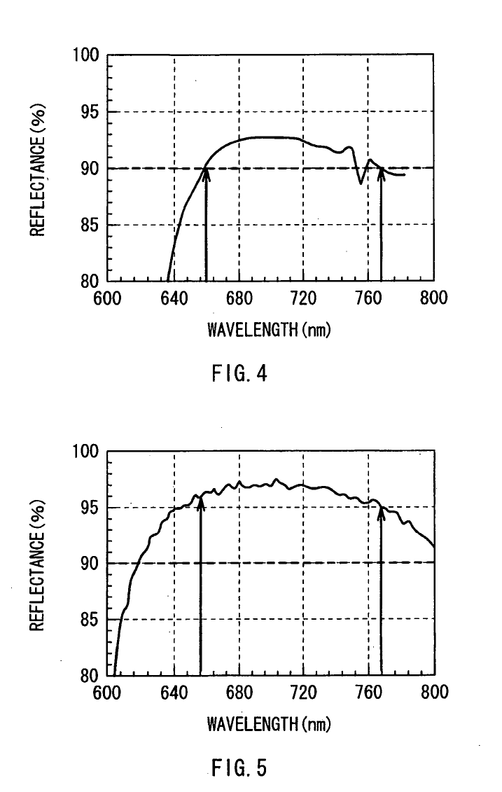

For example, as shown in FIG. 4, in the rear end face film in which a film with high reflectance is made of an Al₂O₃ film with a film thickness of 720 nm and a film with low reflectance is made of a TiO₂ film with a film thickness of 720 nm, and in which five layers of the set of the foregoing Al₂O₃ film and the foregoing TiO₂ film are layered, the both ends of the waveband corresponding to the reflectance in the practical range are exactly the wavelength 660 nm of one laser light and the wavelength 780 nm of the other laser light. Thus, it can be confirmed that the waveband corresponding to the reflectance in the practical range is significantly narrow. Further, accordingly, both in the 660 nm band and in the 780 nm band, the corresponding reflectance is the lower limit reflectance of the practical range (90%). Therefore, when the film thickness of each film composing the rear end face film varies according to manufacturing error or the like, reflectance in the waveband of at least one laser light may become lower than the practical range, and the yield may be decreased.

On the other hand, the rear end face film of this embodiment includes the rear end face film 31 composed of the plurality of reflective films (the first reflective film 32 and the second reflective film 33). Therefore, the range of choice in terms of arrangement, the number of layers, materials and the like for each reflective film can be widened. Thereby, the waveband corresponding to the reflectance in the practical range can be widened.

For example, as shown in FIG. 5, in the rear end face film 31, in which the first rear end face film 32A is made of an Al₂O₃ film with a film thickness of 720 nm, the second rear end face film 32B is made of a TiO₂ film with a film thickness of 720 nm, the third rear end face film 33A is made of a SiO₂ film with a film thickness of 720 nm, and the fourth rear end face film 33B is made of a TiO₂ film with a film thickness of 720 nm, and in which one set of the first rear end face film 32A and the second rear end face film 32B and three sets of the third rear end face film 33A and the fourth rear end face film 33B are layered, the both ends of the waveband corresponding to the reflectance in the practical range are 620 nm and 810 nm. Thus, the waveband corresponding to the reflectance in the practical range is significantly wide, and has a sufficient margin. Further, accordingly, it can be confirmed that high reflectance of 95% can be obtained both in the 660 nm band and in the 780 nm band, and such a value significantly exceeds the lower limit reflectance in the practical range (90%). Thereby, even if the film thickness of each film composing the rear end face film 31 varies according to manufacturing error or the like, there is no risk that the relevant reflectance is less than the lower limit reflectance in the practical range, or there is no risk that the yield is lowered.

In the two-wavelength laser diode device according to this embodiment, the use of SiO₂ in the rear end face film 31 is curtailed. Therefore, in addition to the high reflectance and the sufficient margin, the two-wavelength laser diode device has heat release characteristics in the practical range and can further improve the throughput.

As above, according to the two-wavelength laser diode device of this embodiment, the rear end face film 31 composed of the plurality of reflective films (the first reflective film 32 and the second reflective film 33) is included. Therefore, the heat release characteristics and the film-forming speed can be improved, and the reflectance of the rear end face film 31 can be high in the wide band. In the result, high reflectance can be realized both in the 660 nm band and in the 780 nm band with heat release characteristics and film-forming speed in the practical range.

The front end face film 51 has a single structure formed in one process on the front end face as described above. Thus, the front end face film 51 does not have a plurality of structures in which the material, the thickness, the layer structure and the like are adjusted according to the site from which laser light is emitted. Therefore, it is necessary to realize reflectance to meet a given specification for laser light in the both wavelengths by a single structure (a specification that reflectance both in the 660 nm band and in the 780 nm band is from 6% to 8% (first specification).

In general, the single structured front end face film has a single layer structure. Otherwise, the single structured front end face film has a structure in which one or a plurality of sets of a high refractive index layer with a thickness of λo and a low refractive index layer with a thickness of λo are layered where an intermediate wavelength (λ1+λ2)/2 obtained by adding a wavelength λ1 of one laser light and a wavelength λ2 of the other laser light and dividing the sum by 2 is λo. In the front end face film having such a structure, reflectance in each waveband of the laser light emitted from the two-wavelength laser diode is difficult to be controlled independently. Therefore, if the reflectance meeting a specification can be obtained for each waveband, it is a reality that there is almost no thickness margin for the specification. In the result, when the thickness of the single layer structure or the thickness of each layer composing the multilayer structure varies according to manufacturing error or the like, reflectance in the waveband of either laser light may be out of the specification, and the yield may be decreased. In particular, in the two-wavelength laser diode in the 660 nm band and the 780 nm band, it is extremely difficult to form a layer structure meeting a given specification considering manufacturing error or the like.

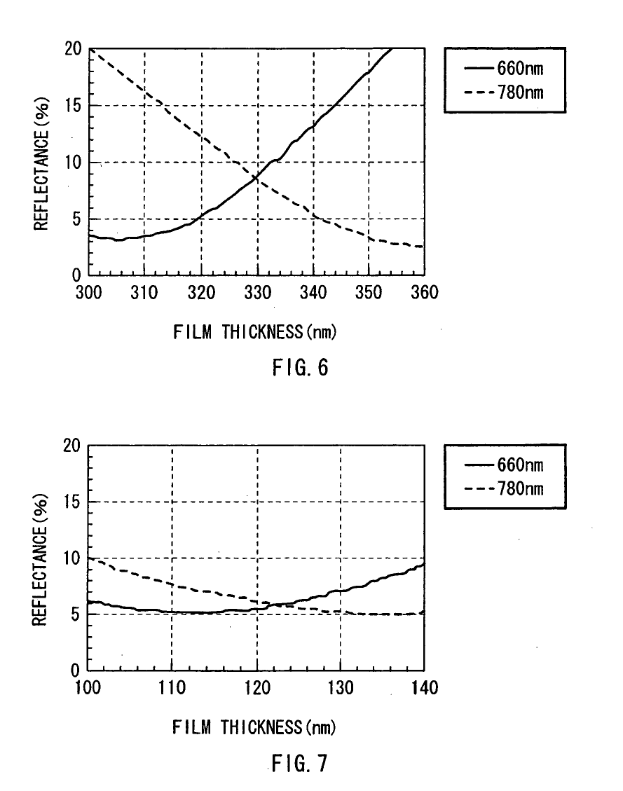

For example, as shown in FIG. 6, in the front end face film having a single layer structure made of Al₂O₃, the thickness satisfying the foregoing specification is only about 330 nm and the reflectance is 8%, which is the upper limit of the specification. Therefore, when the thickness of each layer composing the front end face film varies according to manufacturing error or the like, reflectance in the waveband of at least one laser light may be out of the specification, and the yield may be decreased. Therefore, it can be confirmed that it is extremely difficult that the reflectance both in the 660 nm band and in the 780 nm band meets a given specification.

Meanwhile, in the two-wavelength laser diode device of this embodiment, in the single structured front end face film 51, the high refractive index layer 52 and the low refractive index layer 53 are layered in this order on the front end face, and the thickness of the high refractive index layer is a value which is not a function of laser light wavelength. Therefore, reflectance in the 660 nm band and in the 780 nm band can be controlled relatively freely, and the thickness margin for the reflectance in these wavelengths can be wide.

For example, as shown in FIG. 7, when the high refractive index layer 52 is an Al₂O₃ layer being 50 nm thick, the foregoing specification is met if the low refractive index layer 53 is a SiO₂ layer being from 50 nm to 70 nm thick. Otherwise, though not shown, when the high refractive index layer 52 is an Al₂O₃ layer being 45 nm thick, the foregoing specification is met if the low refractive index layer 53 is a SiO₂ layer being from 60 nm to 90 nm thick. Otherwise, when the high refractive index layer 52 is an Al₂O₃ layer being 60 nm thick, the low refractive index layer 53 may be a SiO₂ layer being from 40 nm to 80 nm thick. As above, it can be confirmed that when the high refractive index layer 52 is an Al₂O₃ layer being from 45 nm to 60 nm thick, the foregoing specification can be met, and the thickness margin for the reflectance in the 660 nm band and in the 780 nm band is large. Further, it can be confirmed that the thickness of the front end face film 51 of FIG. 7 is significantly thin compared to that of the front end face film of FIG. 6.

As above, according to the two-wavelength laser diode device of this embodiment, the front end face film 51 in which the high refractive index layer 52 and the low refractive index layer 53 are layered in this order is included. In addition, the thickness of the high refractive index layer 52 is a value which is not a function of laser light wavelength. Therefore, the thickness margin for the reflectance in the 660 nm band and in the 780 nm band becomes large. Thereby, even if the thickness of each layer composing the multilayer structure varies according to manufacturing error or the like, there is no risk that reflectance in the wavelength band of either laser light becomes out of the specification, or there is no risk that the yield ratio is lowered. In the result, reflectance in the 660 nm band and in the 780 nm band can meet a given specification.

Further, since the front end face film 51 has a multilayer structure, the thickness thereof can be thinner than in the single layer structure.

[Second Embodiment]

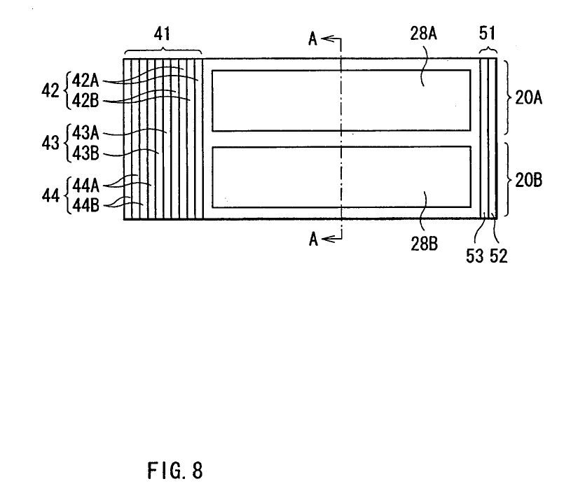

Next, a two-wavelength laser diode device according to a second embodiment of the present invention will be described. FIG. 8 shows a planar structure of the two-wavelength laser diode device according to this embodiment. FIG. 8 shows a model of the two-wavelength laser diode device, and the dimensions and the shape are different from those used actually.

When compared to the structure of the foregoing first embodiment, the two-wavelength laser diode device is different in including a rear end face film 41. Thus, descriptions of the structure, the action and the effect similar to of the first embodiment will be omitted as appropriate, and descriptions will be hereinafter mainly given of the rear end face film 41.

The rear end face film 41 has a first reflective film 42 in which one or a plurality of sets of a first rear end face 42A with a refractive index of n1 and a film thickness of λo and a second rear end face film 42B with a refractive index of n2 (>n1) and a film thickness of λo are layered on the rear end face, a second reflective film 43 in which one or a plurality of sets of a third rear end face film 43A with a refractive index of n3 (≦n1) and a film thickness of λo and a fourth rear end face film 43B with a refractive index of n4 (>n1) and a film thickness of λo are layered on the first reflective film 42, and a third reflective film 44 in which one or a plurality of sets of a fifth rear end face film 44A with a refractive index of n5 (≦n1) and a film thickness of λo and a sixth rear end face film 44B with a refractive index of n6 (>n1) and a film thickness of λo are layered on the second reflective film 43.

Specifically, the first rear end face film 42A is made of Al₂O₃ (thermal conductivity: 0.2, refractive index n1: 1.65) or AlN (thermal conductivity: 2.85, refractive index n1: 2.11). The second rear end face film 42B is made of TiO₂ (refractive index n2 : 2.45 (>n1)). Thereby, the first reflective film 42 has both a heat release function and a reflective function similarly to the first reflective film 32. The third rear end face film 43A is made of Al₂O₃ (thermal conductivity: 0.2, refractive index n3: 1.65 (=n1)) or AlN (thermal conductivity: 2.85, refractive index n3: 2.11 (<n1)). The fourth rear end face film 43B is made of a-Si (refractive index n4: 3.65 (>n1)). Since the refractive index difference between a-Si and TiO₂ is large, 2.2, the second reflective film 43 has a high reflective function. The fifth rear end face film 44A is made of Al₂O₃ (thermal conductivity: 0.2, refractive index n5: 1.65 (n=1)) or AlN (thermal conductivity: 2.85, refractive index n1: 2.11 (<n1)). The sixth rear end face film 44B is made of TiO₂ (refractive index n6: 2.45 (>n1)). Thereby, the third reflective film 44 has both a heat release function and a reflective function similarly to the first reflective film 42.

The foregoing a-Si has properties that a-Si absorbs light at the 660 nm band. Thus, it is desirable to keep the a-Si layer away from the rear end face. Therefore, in this embodiment, as described above, by forming the first reflective film 42 between the a-Si layer and the rear end face, light absorption is reduced, and high reflectance can be realized in the 660 nm band.

As above, by forming the rear end face film 41 from the plurality reflective films (the first reflective film 42, the second reflective film 43, and the third reflective film 43), the range of choice in terms of arrangement, the number of layers, materials and the like for each reflective film can be widened. Thereby, as described above, unfavorable characteristics of one material can be improved with arrangement, the total number of layers, or other material. In the result, the waveband corresponding to the reflectance in the practical range can be widened with heat release characteristics and film-forming speed in the practical range.

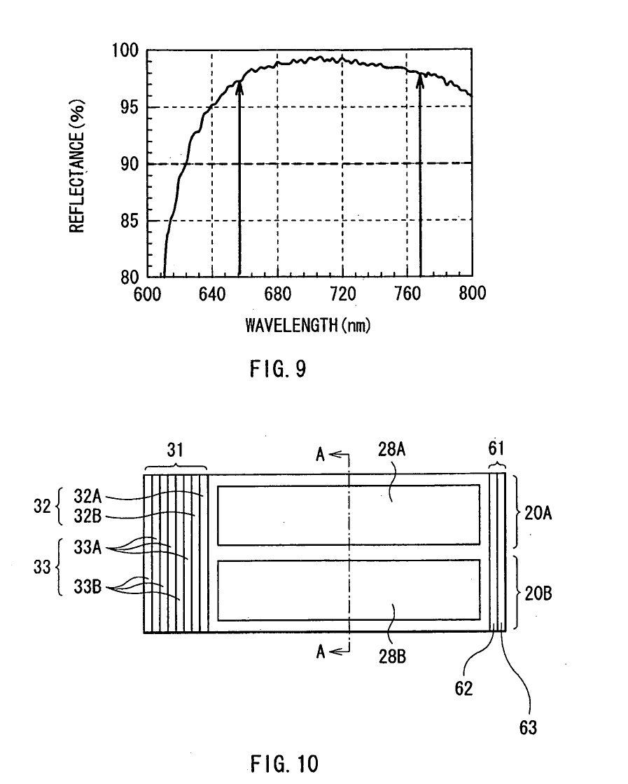

FIG. 9 shows an example of the rear end face film 41. In the rear end face film 41 of FIG. 9, the first rear end face film 42A is made of an Al₂O₃ film with a film thickness of 720 nm, the second rear end face film 42B is made of a TiO₂ film with a film thickness of 720 nm, the third rear end face film 43A is made of an Al₂O₃ film with a film thickness of 720 nm, the fourth rear end face film 43B is made of an a-Si film with a film thickness of 720 nm, the fifth rear end face film 44A is made of an Al₂O₃ film with a film thickness of 720 nm, and the sixth rear end face film 44B is made of a TiO₂ film with a film thickness of 720 nm. The rear end face film 41 has a structure in which two sets of the first rear end face film 42A and the second rear end face film 42B, one set of the third rear end face film 43A and the fourth rear end face film 43B, and two sets of the fifth rear end face film 44A and the sixth rear end face film 44B are layered.

As above, by providing the a-Si film apart from the rear end face, the both ends of the waveband corresponding to the reflectance in the practical range are 620 nm and 900 nm. Thus, it can be confirmed that the waveband corresponding to the reflectance in the practical range is significantly wide, and has a sufficient margin. Further, accordingly, it can be confirmed that high reflectance of 97% can be obtained both in the 660 nm band and in the 780 nm band, and such a value significantly exceeds the lower limit reflectance in the practical range (90%). Thereby, even if the film thickness of each film composing the rear end face film 41 varies according to manufacturing error or the like, there is no risk that the reflectance is less than the lower limit reflectance in the practical range, or there is no risk that the yield is lowered.

In the two-wavelength laser diode device of this embodiment, the first reflective film 42 and the third reflective film 44 have a heat release function, and SiO₂ is not used for the rear end face film 41. Therefore, the two-wavelength laser diode device of this embodiment has heat release characteristics in the practical range and can further improve throughput in addition to that the two-wavelength laser diode device has the high reflectance and the sufficient margin.

As above, according to the two-wavelength laser diode device of this embodiment, the rear end face film 41 composed of the plurality of reflective films (the first reflective film 42, the second reflective film 43, and the third reflective film 44) is included. Therefore, the heat release characteristics and the film-forming speed can be improved, and the reflectance of the rear end face film 41 can be high in the wide band. In the result, high reflectance can be realized both in the 660 nm band and in the 780 nm band with heat release characteristics and film-forming speed in the practical range.

[Third Embodiment]

Next, a two-wavelength laser diode device according to a third embodiment of the present invention will be described. FIG. 10 shows a planar structure of the two-wavelength laser diode device according to this embodiment. FIG. 10 shows a model of the two-wavelength laser diode device, and the dimensions and the shape are different from those used actually.

When compared to the structure of the foregoing first embodiment, the two-wavelength laser diode device is different in including a front end face film 61. Thus, descriptions of the structure, the action, and the effect similar to of the first embodiment will be omitted as appropriate, and descriptions will be hereinafter mainly given of the front end face film 61.

The front end face film 61 has a multilayer structure in which a high refractive index layer 62 with a given thickness and a low refractive index layer 63 with a thickness corresponding to the thickness of the high refractive index layer 62 are layered in this order on the front end face. Adjustment is made so that a specification that reflectance in the 660 nm band is from 6% to 8% and reflectance in the 780 nm band is 20% or more (hereinafter referred to as “second specification”) can be met.

Specifically, similarly to the front end face film 51 of the first embodiment, in the front end face film 61, the high refractive index layer 62 is made of an Al₂O₃ layer, and the low refractive index layer 63 is made of a SiO₂ layer. The Al₂O₃ layer and the SiO₂ layer have a thickness different from the value derived from a function of laser light wavelength. For example, the thickness of the Al₂O₃ layer is from 210 nm to 230 nm, and the thickness of the SiO₂ layer is from 70 nm to 110 nm.

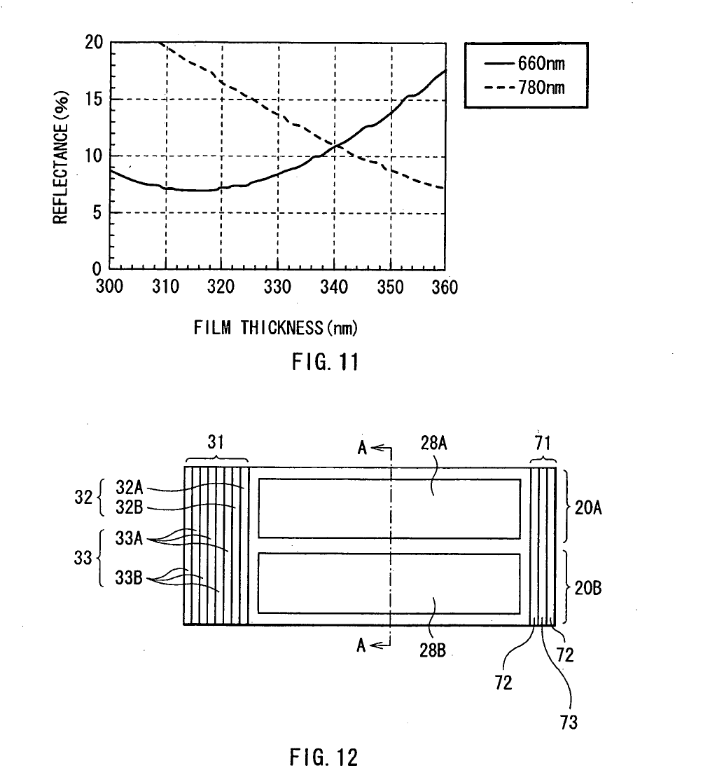

FIG. 11 shows an example of a reflectance distribution of the front end face film 61. As shown in FIG. 11, when the high refractive index layer 62 is an Al₂O₃ layer being about 220 nm thick, the foregoing specification is met if the low refractive index layer 63 is a SiO₂ layer being from 80 nm to 110 nm thick. Otherwise, though not shown, when the high refractive index layer 62 is an Al₂O₃ layer being about 210 nm thick, the foregoing specification is met if the low refractive index layer 63 is a SiO₂ layer being from 75 nm to 105 nm thick. Otherwise, when the high refractive index layer 62 is an Al₂O₃ layer being about 230 nm thick, the low refractive index layer 63 may be a SiO₂ layer being from 70 nm to 100 nm thick. As above, it can be confirmed that when the high refractive index layer 62 is an Al₂O₃ layer being from 210 nm to 230 nm thick, the foregoing specification can be met, and the thickness margin for the reflectance in the 660 nm band and in the 780 nm band is large.

Further, in the front end face film 61 of FIG. 11, when the thickness of the front end face film 61 is set to the range from 305 nm to 325 nm, reflectance in the 660 nm band is almost constant in the specification range (range from 6% to 8%). Therefore, when the thickness of the low refractive index layer 63 is changed in the range from 85 nm to 105 nm, the reflectance in the 780 nm band can be changed and set to in the specification range (20% or more) without changing the reflectance in the 660 nm band. Thereby, it can be confirmed that by setting the thickness of the high refractive index layer 62 to a given thickness and changing the thickness of the low refractive index layer 63, the reflectance in the 660 nm band and in the 780 nm band can be independently controlled.

As above, according to the two-wavelength laser diode device of this embodiment, the front end face film 61 in which the high refractive index layer 62 and the low refractive index layer 63 are layered in this order is included. In addition, the thickness of the high refractive index layer 62 is the value which is not a function of laser light wavelength. Therefore, the thickness margin for the reflectance in the 660 nm band and in the 780 nm band becomes large. Thereby, even if the thickness of each layer composing the multilayer structure varies according to manufacturing error or the like, there is no risk that reflectance in the wavelength band of either laser light becomes out of the specification, or there is no risk that the yield ratio is lowered. In the result, reflectance in the 660 nm band and in the 780 nm band can meet a given specification.

Further, by setting the thickness of the high refractive index layer 62 to a given thickness and changing the thickness of the low refractive index layer 63, the reflectance in the 660 nm band and in the 780 nm band can be independently controlled.

[Fourth Embodiment]

Next, a two-wavelength laser diode device according to a fourth embodiment of the present invention will be described. FIG. 12 shows a planar structure of the two-wavelength laser diode device according to this embodiment. FIG. 12 shows a model of the two-wavelength laser diode device, and the dimensions and the shape are different from those used actually.

When compared to the structure of the foregoing first embodiment, the two-wavelength laser diode device is different in including a front end face film 71. Thus, descriptions of the structure, the action, and the effect similar to that of the first embodiment will be omitted as appropriate, and descriptions will be hereinafter mainly given of the front end face film 71.

The front end face film 71 has a multilayer structure in which a high refractive index layer 72 with a given thickness and a low refractive index layer 73 with a thickness corresponding to the thickness of the high refractive index layer 72 are included on the front end face, and the high refractive index layers 72 are provided with the low refractive index layer 73 in between. Adjustment is made so that the first specification can be met.

Specifically, differently from the front end face film 51 of the first embodiment, in the front end face film 71, the high refractive index layer 72 is made of a TiO₂ layer, and the low refractive index layer 73 is made of an Al₂O₃ layer. The TiO₂ layer and the Al₂O₃ layer have a thickness different from the value derived from a function of laser light wavelength. For example, the thickness of the TiO₂ layer is from 10 nm to 15 nm, and the thickness of the Al₂O₃ layer is from 15 nm to 100 nm.

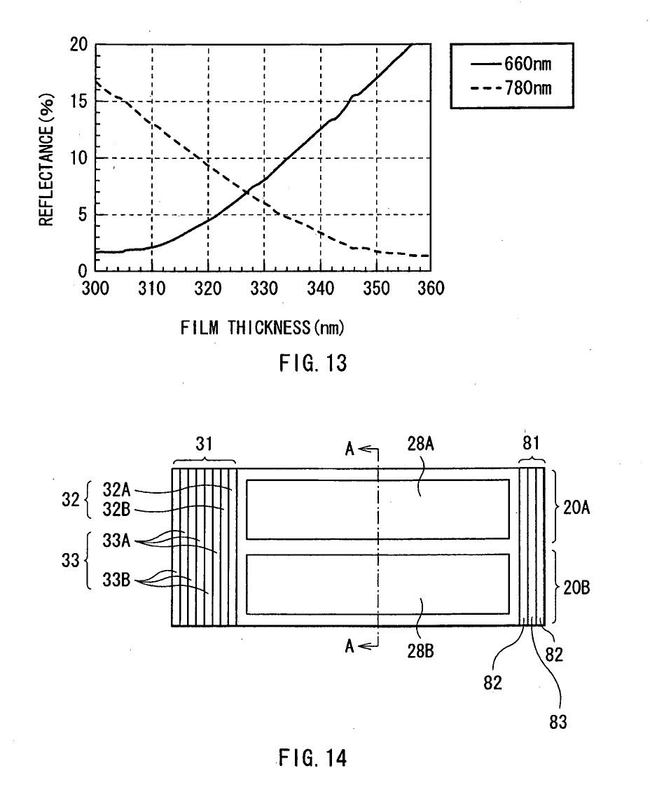

FIG. 13 shows an example of a reflectance distribution of the front end face film 71. As shown in FIG. 13, when the high refractive index layer 72 is a TiO₂ layer being about 12.5 nm thick, the foregoing specification is met if the low refractive index layer 73 is an Al₂O₃ layer being from 15 nm to 100 nm thick. Otherwise, though not shown, when the high refractive index layer 72 is a TiO₂ layer being about 10 nm thick, the foregoing specification is met if the low refractive index layer 73 is an Al₂O₃ layer being from 15 nm to 100 nm thick. Otherwise, when the high refractive index layer 72 is a TiO₂ layer being about 15 nm thick, the low refractive index layer 73 may be an Al₂O₃ layer being from 15 nm to 100 nm thick. As above, it can be confirmed that when the high refractive index layer 72 is a TiO₂ layer being from 10 nm to 15 nm thick, the foregoing specification can be met, and the thickness margin for the reflectance in the 660 nm band and in the 780 nm band is large.

As above, according to the two-wavelength laser diode device of this embodiment, the front end face film 71 in which the high refractive index layer 72 and the low refractive index layer 73 are included is provided. In addition, the thickness of the high refractive index layer 72 is a value which is not a function of laser light wavelength. Therefore, the thickness margin for the reflectance in the 660 nm band and in the 780 nm band becomes large. Thereby, even if the thickness of each layer composing the multilayer structure varies according to manufacturing error or the like, there is no risk that reflectance in the waveband of either laser light becomes out of the specification, or there is no risk that the yield ratio is lowered. In the result, reflectance in the 660 nm band and in the 780 nm band can meet a given specification.

[Fifth Embodiment]

Next, a two-wavelength laser diode device according to a fifth embodiment of the present invention will be described. FIG. 14 shows a planar structure of the two-wavelength laser diode device according to this embodiment. FIG. 14 shows a model of the two-wavelength laser diode device, and the dimensions and the shape are different from those used actually.

When compared to the structure of the foregoing fourth embodiment, the two-wavelength laser diode device is different in including a front end face film 81. Thus, descriptions of the structure, the action, and the effect similar to that of the fourth embodiment will be omitted as appropriate, and descriptions will be hereinafter mainly given of the front end face film 81.

The front end face film 81 has a multilayer structure in which a high refractive index layer 82 with a given thickness and a low refractive index layer 83 with a thickness corresponding to the thickness of the high refractive index layer 82 are included on the front end face, and the high refractive index layers 82 are provided with the low refractive index layer 83 in between. Adjustment is made so that a specification that reflectance in the 660 nm band is 6% or more and reflectance in the 780 nm band is from 6% to 8% (hereinafter referred to as “third specification”) can be met.

Specifically, similarly to in the foregoing fourth embodiment, in the front end face film 81, the high refractive index layer 82 is made of a TiO₂ layer, and the low refractive index layer 83 is made of an Al₂O₃ layer. The TiO₂ layer and the Al₂O₃ layer have a thickness different from the value derived from a function of laser light wavelength. For example, the thickness of the TiO₂ layer is from 55 nm to 65 nm, and the thickness of the Al₂O₃ layer is from 15 nm to 100 nm.

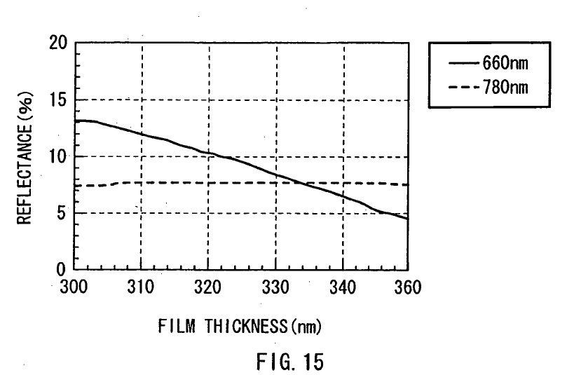

FIG. 15 shows an example of a reflectance distribution of the front end face film 81. As shown in FIG. 15, when the high refractive index layer 82 is a TiO₂ layer being about 60 nm thick, the foregoing specification is met if the low refractive index layer 83 is an Al₂O₃ layer being from 55 nm to 65 nm thick. Otherwise, though not shown, when the high refractive index layer 82 is a TiO₂ layer being about 55 nm thick, the foregoing specification is met if the low refractive index layer 83 is an Al₂O₃ layer being from 15 nm to 100 nm thick. Otherwise, when the high refractive index layer 82 is a TiO₂ layer being about 65 nm thick, the low refractive index layer 83 may be an Al₂O₃ layer being from 15 nm to 100 nm thick. As above, it can be confirmed that when the high refractive index layer 82 is a TiO₂ layer being from 55 nm to 65 nm thick, the foregoing specification can be met, and the thickness margin for the reflectance in the 660 nm band and in the 780 nm band is large.

Further, in the front end face film 81 of FIG. 15, when the thickness of the front end face film 81 is set to the range at least from 150 nm to 200 nm, the reflectance in the 780 nm band is almost constant in the specification range (range from 6% to 8%). Therefore, when the thickness of the low refractive index layer 83 is changed in the range at least from 90 nm to 140 nm, the reflectance in the 660 nm band can be changed and set to in the specification range (6% or more) without changing the reflectance in the 780 nm band. Thereby, it can be confirmed that by setting the thickness of the high refractive index layer 82 to a given thickness and changing the thickness of the low refractive index layer 83, the reflectance in the 660 nm band and in the 780 nm band can be independently controlled.

As above, according to the two-wavelength laser diode device of this embodiment, the front end face film 81 in which the high refractive index layer 82 and the low refractive index layer 83 are included is provided. In addition, the thickness of the high refractive index layer 82 is a value which is not a function of laser light wavelength. Therefore, the thickness margin for the reflectance in the 660 nm band and in the 780 nm band becomes large. Thereby, even if the thickness of each layer composing the multilayer structure varies according to manufacturing error or the like, there is no risk that reflectance in the waveband of either laser light becomes out of the specification, or there is no risk that the yield ratio is lowered. In the result, reflectance in the 660 nm band and in the 780 nm band can meet a given specification.

Further, by setting the thickness of the high refractive index layer 82 to a given thickness and changing the thickness of the low refractive index layer 83, reflectance in the 660 nm band and in the 780 nm band can be independently controlled.

While descriptions have been hereinbefore given of the present invention with reference to the embodiments, the present invention is not limited to the foregoing embodiments, and various modifications may be made.

For example, in the foregoing embodiments, the case applying the present invention to the two-wavelength laser diode device has been described. However, the present invention is not limited to the foregoing two-wavelength laser diode device, but can be applied to multiwavelength laser diode. At that time, the rear end face film by which laser light in waveband other than the 660 nm band and the 780 nm band is reflected may be formed in one process together with the foregoing front end face film 31 or 41, or may be formed separately. Further, the front end face film by which laser light in waveband other than the 660 nm band and the 780 nm band is reflected may be formed in one process together with the foregoing front end face film 51, 61, 71, or 81, or may be formed separately. Further, the present invention can be applied to a laser diode device in which a plurality of laser light of at least one in the 660 nm band and in the 780 nm band are emitted.

Further, in the foregoing embodiments, descriptions have been given with reference to the AlGaInP Group III-V compound laser diode device as the first device portion 20A and the GaAs Group III-V compound laser diode device as the second device portion 20B and with examples of the compositions and the structures thereof. However, the present invention can be similarly applied to a laser diode device having other composition or other structure.

It should be understood by those skilled in the art that various modifications, combinations, sub-combinations and alternations may occur depending on design requirements and other factors insofar as they are within the scope of the appended claims or the equivalents thereof.

What is claimed is:

1. A multiwavelength laser diode comprising:
a substrate;
a first device portion which is formed on the substrate and oscillates laser light of a first wavelength;
a second device portion which is formed on the substrate and oscillates laser light of a second wavelength;
a front end face film formed in one process on a front end face of the first device portion and a front end face of the second device portion; and
a rear end face film formed in one process on a rear end face of the first device portion and a rear end face of the second device portion,
wherein the rear end face film has
a first reflective film in which one or a plurality of sets of a first rear end face film with a refractive index of n1 and a second rear end face film with a refractive index of n2 (>n1) are layered on the rear end face, and
a second reflective film in which one or a plurality of sets of a third rear end face film with a refractive index of n3 (≦n1) and a fourth rear end face film with a refractive index of n4 (>n1) are layered on the first reflective film.

2. The multiwavelength laser diode according to claim 1, wherein the first rear end face film includes an Al₂O₃ film or an AlN film,
the second rear end face film includes a TiO₂ film,
the third rear end face film includes a SiO₂ film, and
the fourth rear end face film includes a TiO₂ film.

3. The multiwavelength laser diode according to claim 1, wherein the rear end face film further includes a third reflective film in which one or a plurality of sets of a fifth rear end face film with a refractive index of n5 (≦n1) and a sixth rear end face film with a refractive index of n6 (>n1) are layered on the second reflective film,
the first rear end face film includes an Al₂O₃ film or an AlN film,
the second rear end face film includes a TiO₂ film,
the third rear end face film includes an Al₂O₃ film or an AlN film,
the fourth rear end face film includes an a-Si film,
the fifth rear end face film includes an Al₂O₃ film or an AlN film, and
the sixth rear end face film includes a TiO₂ film.

4. The multiwavelength laser diode according to claim 1, wherein the front end face film includes a high refractive index layer with a given thickness and a low refractive index layer having a thickness corresponding to the thickness of the high refractive index layer on the rear end face.

5. The multiwavelength laser diode according to claim 4, wherein the high refractive index layer is an Al₂O₃ layer being from 30 nm to 60 nm thick, and
the low refractive index layer is a SiO₂ layer being from 40 nm to 120 nm thick.

6. The multiwavelength laser diode according to claim 5, wherein when the thickness of the Al₂O₃ layer is about 30 nm, the thickness of the SiO₂ layer is from 85 nm to 120 nm,
when the thickness of the Al₂O₃ layer is about 50 nm, the thickness of the SiO₂ layer is from 50 nm to 70 nm, and
when the thickness of the Al₂O₃ layer is about 60 nm, the thickness of the SiO₂ layer is from 40 nm to 80 nm.

7. The multiwavelength laser diode according to claim 4, wherein the high refractive index layer is a TiO₂ layer being from 10 nm to 15 nm thick, and
the low refractive index layer is an Al₂O₃ layer being from 15 nm to 100 nm thick.

8. The multiwavelength laser diode according to claim 4, wherein the high refractive index layer is an Al₂O₃ layer being from 210 nm to 230 nm thick, and
the low refractive index layer is a SiO₂ layer being from 70 nm to 110 nm thick.

9. The multiwavelength laser diode according to claim 8, wherein when the thickness of the Al₂O₃ layer is about 210 nm, the thickness of the SiO₂ layer is from 80 nm to 110 nm,
when the thickness of the Al₂O₃ layer is about 220 nm, the thickness of the SiO₂ layer is from 75 nm to 105 nm, and
when the thickness of the Al₂O₃ layer is about 230 nm, the thickness of the SiO₂ layer is from 70 nm to 100 nm.

10. The multiwavelength laser diode according to claim 4, wherein the high refractive index layer is a TiO₂ layer being from 55 nm to 65 nm thick, and
the low refractive index layer is an Al₂O₃ layer being from 15 nm to 100 nm thick.
